(19) United States
(12) Patent Application Publication
(10) Pub. No.: US 2014/0170361 A1
(43) Pub. Date: Jun. 19, 2014

(54) FRP Plate and Manufacturing Method Thereof

(71) Applicant: Suzhou More V Composite Material Co., Ltd, Taicang (CN)

(72) Inventors: Yongjie Shi, Taicang (CN); Qingping Ai, Taicang (CN)

(73) Assignee: Suzhou More V Composite Material Co., Ltd, Taicang (CN)

(21) Appl. No.: 14/100,665

(22) Filed: Dec. 9, 2013

(30) Foreign Application Priority Data
Dec. 13, 2012 (CN) CN201210536474.9

(51) Int. Cl. B32B 5/26

(52) U.S. Cl. CPC B32B 5/26
USPC 428/41.8; 156/250

(57) ABSTRACT

A FRP plate and manufacturing method thereof are provided in the invention. The FRP plate comprises: a lower layer of polyester carrier film; a mixed layer located on the lower layer of polyester carrier film, which is formed by curing a melted polyester resin in which a glass fiber reinforced material is embedded; and an upper layer of polyester carrier film positioned on the mixed layer. Furthermore, a release fabric is disposed between the mixed layer and the upper layer of polyester carrier film. When the FRP plate of the invention is used, the upper layer of polyester carrier film and the release fabric are torn off so that the surface of the mixed layer is rough, therefore, the adhesion between the FRP plate and other building materials will be greatly improved, and thus the application prospect of the FRP plate is broader.

### RELATED APPLICATIONS

This application claims the benefit of People's Republic of China application Serial No. CN201210536474.9, filed Dec. 13, 2012, under 35 USC Sec. 119(a) hereby specifically incorporated by reference in its entirely.

### FIELD OF THE INVENTION

The invention relates to the field of FRP, and more particularly to a FRP plate with a rough surface and strong adhesion, as well as manufacturing method thereof.

### DESCRIPTION OF THE RELATED ART

FRP (Glass Fiber reinforced plastics, also known as Fiber Reinforced Plastics for short) holds many excellent virtues which are absent in conventional building materials, such as lightness and high strength, electromagnetic wave transparent, corrosion resistance, heat preservation and good sound proof property. FRP also has other good properties such as photopermeability, anti-vibration, and convenient shaping, and thus it is increasingly used in the building field. However, when the FRP is bonded to other building materials, various problems are existed such as poor adhesion and easy to fall off, due to the smooth and low-polarity surface of FRP, therefore, the application of FRP is limited.

### SUMMARY OF THE INVENTION

An object of the invention is to provide a FRP plate with strong adhesion.

In order to achieve the above purpose, the following technical solutions are provided:

In one aspect, the invention discloses a FRP plate, which comprises a lower layer of polyester carrier film; a mixed layer located on the lower layer of polyester carrier film, which is formed by curing a melted polyester resin in which a glass fiber reinforced material is embedded; and an upper layer of polyester carrier film positioned on the mixed layer; and a release fabric is disposed between the mixed layer and the upper layer of polyester carrier film.

Preferably, the mixed layer is fully covered by the release fabric which is one-piece.

More preferably, there are a plurality of release fabrics which are disposed equally spaced from and parallel to each other.

Still more preferably, the release fabric is woven from nylon or polyester fiber.

Preferably, the polyester resin is selected from the group of orthophthalic resin, isophthalic resin, terephthalic resin, vinyl resin, epoxy resin or any combination thereof.

Preferably, the glass fiber reinforced material is selected from glass fiber chopped yarn, felt, cloth or textile thereof, or any combination of them.

More preferably, the diameter of the glass fiber in the glass fiber chopped yarn, felt, cloth or textile thereof is 8˜16 μm.

In another aspect, the present invention also discloses a method for manufacturing the above FRP plate, which comprises steps of:

(a) moving a lower layer of polyester carrier film wound on a rotation shaft in a direction at a speed by means of a traction engine, and wherein the lower layer of polyester carrier film being moved synchronously with the free end of the traction engine;

(b) sequentially paving a polyester resin, a glass fiber reinforced material, and a release fabric on the lower layer of polyester carrier film to obtain a FRP plate blank, and paving a upper layer of polyester carrier film on the FRP plate blank after the blank is infiltrated, deaerated and pressed by a roller, and then controlling the thickness of the FRP plate blank by a glue extruding roller;

(c) transferring the FRP plate blank from the glue extruding roller into a heating furnace for heat setting;

(d) cutting the FRP plate into pieces by a cutter after it is shaped and out of the heating furnace.

Preferably, the method also comprise a step of flattening the polyester resin after it is paved on the lower layer of polyester carrier film, and wherein a scraper spanned above a convey for flattening the polyester resin being disposed between the working positions for paving the polyester resin and the glass fiber reinforced material.

The invention has the following advantages due to the above technical solution: in the FRP plate of the invention a release fabric is disposed between the mixed layer and the upper layer of polyester carrier film, when the FRP is used, the upper layer of polyester carrier film together with the release fabric are torn off so that the surface of the mixed layer is rough, this greatly increases the adhesion between the FRP plate and the other building materials, thus making the application prospect of the FRP plate more broader.

### BRIEF DESCRIPTION OF THE DRAWINGS

FIG. 1 is a schematic drawing showing a FRP plate of the invention;

FIG. 2 is a flow chart illustrating the manufacturing process of the FRP plate of the invention;

### DETAILED DESCRIPTION OF THE INVENTION

The present invention will be described hereinafter with reference to the accompanying drawings. It is to be noted, however, that the drawings are given only for illustrative purpose and therefore not to be considered as limiting of its scope, for the invention may admit to other equally effective embodiments.

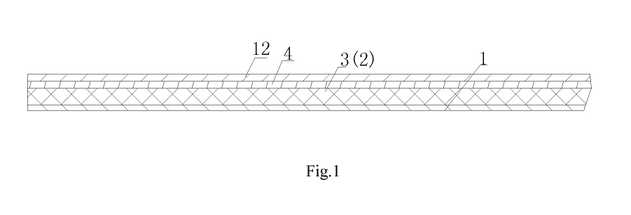

In the embodiment shown in FIG. 1, the FRP plate comprises a lower layer of polyester carrier film 1, a mixed layer 32 located on the lower layer of polyester carrier film 1, which is formed by curing a melted polyester resin in which a glass fiber reinforced material is embedded, and a upper layer of polyester carrier film 12 positioned on the mixed layer 32, as well as a release fabric 4 disposed between the mixed layer 32 and the upper layer of polyester carrier film 12.

In this embodiment, the glass fiber reinforced material 2 is a mixture from any combination of glass fiber chopped yarn, felt, cloth or textile thereof, and the diameter of the glass fiber in the glass fiber chopped yarn, felt, cloth or textile thereof is 8˜16 μm.

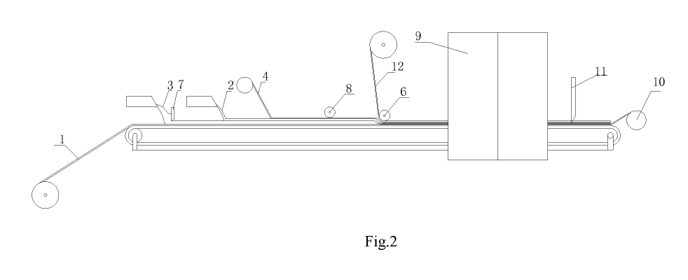

The FIG. 2 shows a flow chart for the manufacturing process of the above FRP plate, the manufacturing process comprises the following steps:

(a) moving a lower layer of polyester carrier film 1 wound on a rotation shaft in a direction at a speed by means of a traction engine 10, and wherein the lower layer of polyester carrier film being moved synchronously with the free end of the traction engine 10;

(b) sequentially paving a polyester resin 3, a glass fiber reinforced material 2, and a release fabric 4 on the lower layer of polyester carrier film 1 to obtain a FRP plate blank, and paving a upper layer of polyester carrier film 12 on the FRP plate blank after the blank is infiltrated, deaerated and pressed by a roller 8, and then controlling the thickness of the FRP plate blank by a glue extruding roller 6;

(c) transferring the FRP plate blank from the glue extruding roller 6 into a heating furnace 9 for heat setting;

(d) cutting the FRP plate into pieces by a cutter 11 after it is shaped and out of the heating furnace 9.

It is should be noted that, the release fabric 4 may be one-piece and fully cover the mixed layer, and also possibly there are multiple release fabrics 4 which are disposed equally spaced from and parallel to each other. It is necessary to flatten the polyester resin 3 after it is paved on the lower layer of polyester carrier film 1, and a scraper 7 spanned above a convey for flattening the polyester resin 3 is disposed between the working positions for paving the polyester resin 3 and the glass fiber reinforced material 2.

The release fabric 4 is made of nylon or polyester. In this embodiment, the release fabric 4 is a one-piece nylon fabric which is provided with a rough texture. The mixed layer 32 which is formed by curing a melted polyester resin 3 in which a glass fiber reinforced material is embedded is fully covered by the release fabric 4. The surface of the polyester resin 3 will have a corresponding texture before it is cured due to the rough surface of the release fabric 4, when the cured FRP plate is used, the release fabric 4 is torn off so that the surface of the FRP plate is rough due to the presence of the texture. Therefore, the adhesion between the FRP plate and the other building materials will be greatly improved, and thus the application prospect of the FRP plate is wider.

As described above, the detailed description is illustrated according to the spirit of the invention, but the invention is not limited to the aforementioned embodiments and implementing methods. Many variations and implements can be made within the scope of the invention by those skilled in the related art.

What is claimed is:

1. A FRP plate, comprising
a lower layer of polyester carrier film;
a mixed layer located on the lower layer of polyester carrier film, which is formed by curing a melted polyester resin within which a glass fiber reinforced material is embedded; and
an upper layer of polyester carrier film positioned above the mixed layer;
wherein a release fabric is disposed between the mixed layer and the upper layer of polyester carrier film.

2. The FRP plate as claimed in claim 1, wherein the mixed layer is fully covered by the release fabric which is one-piece shaped.

3. The FRP plate as claimed in claim 1, wherein there are a plurality of release fabrics which are disposed equally spaced from and parallel to each other.

4. The FRP plate as claimed in claim 2, wherein the release fabric is nylon-fiber or polyester-fiber woven.

5. The FRP plate as claimed in claim 1, wherein the polyester resin is selected from the group of orthophthalic resin, isophthalic resin, terephthalic resin, vinyl resin, epoxy resin or any combination thereof.

6. The FRP plate as claimed in claim 1, wherein the glass fiber reinforced material is selected from glass fiber chopped yarn, felt, cloth or textile thereof, or any combination of them.

7. The FRP plate as claimed in claim 6, wherein the selected glass fiber chopped yarn, felt, cloth or textile has a glass fiber with a diameter of 8-16 μm.

8. A method for manufacturing the FRP plate in claim 1, comprising steps of:
(a) unwinding a polyester film from a rotation shaft in a direction at a desired speed by pulling of a traction engine to utilizing the polyester film as a required lower layer of polyester carrier film, wherein the polyester film during unwinding moves synchronously with a free end of the traction engine;
(b) successively superimposing a polyester resin, a glass fiber reinforced material, and a release fabric on the lower layer of polyester carrier film to obtain a blank;
(c) infiltrating, deaerating and pressing by a roller the blank, followed by paving a upper layer of polyester carrier film on the blank and then controlling the blank by a glue extruding roller to have a desired thickness;
(d) transferring the blank from the glue extruding roller into a heating furnace for heat setting; and
(e) cutting the FRP plate blank into pieces by a cutter after it is shaped and taken out of the heating furnace.

9. The method for manufacturing the FRP plate as claimed in claim 8, wherein the method also comprise a step of flattening the polyester resin after it is paved on the lower layer of polyester carrier film by a scraper for flattening the polyester resin being disposed above a convey in a crossing direction between working positions for paving the polyester resin and the glass fiber reinforced material.
